(19) United States
(12) Patent Application Publication
(10) Pub. No.: US 2002/0171962 A1
(43) Pub. Date: Nov. 21, 2002

(54) Semiconductor/metal read sensor for magnetic recording

(75) Inventors: Olle Gunnar Heinonen, Eden Prairie, MN (US); Nurul Amin, St. Paul, MN (US)

Correspondence Address: MERCHANT & GOULD PC, P.O. BOX 2903, MINNEAPOLIS, MN, 55402-0903, US

(73) Assignee: Seagate Technology LLC

(21) Appl. No.: 10/145,987

(22) Filed: May 14, 2002

Related U.S. Application Data
(60) Provisional application No. 60/291,194, filed on May 15, 2001.

(51) Int. Cl. G11B 5/03; G11B 21/02

(52) U.S. Cl. 360/66; 360/75

(57) ABSTRACT

Herein is disclosed a method and apparatus for detecting a magnetic field stored upon magnetically-enclosable material with a semiconductor/metal read head. A region of the magnetically-encodable material is brought in proximity to a semiconductor mass with at least one conductive region embedded therein. An electrical current is directed through the semiconductor mass, flowing in a direction approximately parallel to the magnetically-encodable material. The semiconductor mass is magnetically biased. The biasing magnetic field is approximately perpendicular to the magnetically-encodable material. Finally, a change in resistance to current flowing through the semiconductor mass is detected. The change in resistance indicates magnitude and direction of the magnetic field stored upon the magnetically-encodable material.

### RELATED APPLICATIONS

This application claims priority of U.S. provisional application Serial No. 60/291,194, filed May 15, 2001 and entitled “SEMICONDUCTOR/METAL READ SENSOR FOR MAGNETIC RECORDING.”

### FIELD OF THE INVENTION

This application relates generally to disc drives and more particularly to a semiconductor/metal read head within a disc drive.

### BACKGROUND OF THE INVENTION

The storage medium for a disc drive is a flat, circular disc capable of retaining localized magnetic fields. The data that are stored upon the disc find physical representation through these localized magnetic fields. The data are arranged on the disc in concentric, circular paths known as “tracks.” The localized magnetic fields can be detected by a magnetically-sensitive head when they are brought in close proximity to the head. The head is mounted upon the distal end of an actuator arm, which enables the head to move radially to address each track on the disc.

FIG. 1 depicts a read head 100 based on magnetoresistance as known in the prior art. The read head 100 consists of a first magnetic layer 102 and a second magnetic layer 104. The magnetization of the first magnetic layer 102 has a uniform, fixed direction 106, which does not change, even under the influence of another magnetic field. This layer 102 is referred to as the “reference layer.”

The second magnetic layer 104 is referred to as the “free layer.” The free layer 104 has a prevailing magnetization 108 that is free to rotate, the direction of which is determined by the prevailing magnetic field in which it is immersed. A pair of permanent magnets 110 and 112 establishes a normative magnetization direction for the free layer 104. In the absence of any other magnetic influence, the magnetization 108 of the free layer 104 is in the direction of the permanent magnets 110 and 112, as shown by arrow 108. However, when the free layer 104 is brought in proximity to a second magnetic field, its magnetization rotates. The resulting magnetization direction of the free layer 104 is determined by the vector sum of the second magnetic field and the magnetic field established by the permanent magnets 110 and 112 For example, if the free layer 104 is introduced to a second magnetic field represented by vector 114, the resulting magnetization direction of the free layer is represented by vector 116, which is the vector sum of the second magnetic field 114 and the normative magnetic field 108. The second magnetic field 114 may be thought to be that of a localized magnetic field stored upon a disc within a disc drive. Thus, the magnetization direction of the free layer 104 is a function of the localized magnetic field.

To detect the localized magnetic fields stored upon the disc, those fields are brought in proximity to the free layer 104. In response, the magnetization direction of the free layer 104 rotates under the influence of the localized magnetic field, as described above. An electrical current 118 is passed through the free layer 104 and the reference layer 102. The resistance experienced by the electrical current 118 is a function of the angle between the magnetization directions of the free layer 104 and the fixed layer 102. Thus, the resistance experienced by the electrical current 118 varies with the localized magnetic field on the disc. This change in resistance is detected by detection circuitry in the disc drive.

Unfortunately, as depicted in FIG. 1, regions 120 and 122 of the free layer 104, which are in extreme proximity to the permanent magnets 110 and 112, become fixed. These regions 120 and 122 do not respond to the presence of the localized magnetic fields stored upon the disc in the same way that the remainder of the free layer responds. As tracks per linear unit on a disc drive increases (to permit greater data storage), track width decreases. Accordingly, the width 124 of the free layer 104 must also decrease to correspond with the shrunken track width. As the width 124 of the free layer 104 decreases, the unresponsive regions 120 and 122 become closer together, rendering an increasingly greater portion of the surface area of the free layer 104 unresponsive to the influence of localized magnetic fields on the disc. Thus, this phenomenon limits the extent to which read heads may be miniaturized, which in turn limits the extent to which track widths may be reduced. Also, the type of prior art magnetoresistive design, as depicted in FIG. 1, suffers from an unstable magnetization direction on the free layer 104 as the read head 100 is miniaturized. Finally, such a prior art magnetoresistive design, as depicted in FIG. 1, is susceptible to thermal noise as the read head 100 is miniaturized.

As is evident from the preceding discussion, there exists a need for a read head that can be miniaturized to an extent not permitted by a read head utilizing multiple magnetic layers. A desirable embodiment of such a read head should be easily manufacturable.

### SUMMARY OF THE INVENTION

Against this backdrop the present invention has been developed. A disc drive may utilize a read head that includes a ceramic wafer oriented approximately perpendicular to a disc within the disc drive. A semiconductor mass is disposed upon the ceramic wafer. At least one conductive layer is embedded within the mass, and each of the at least one conductivelayers possesses a surface approximately parallel to the wafer. Conductive contact pads disposed on opposite sides of the semiconductor mass. Finally, a bias element is positioned in proximity to the semiconductor mass. The bias element produces a biasing magnetic field within the semiconductor mass.

According to another embodiment of the invention, a method of detecting a magnetic field stored upon magnetically-encodable material involves bringing a region of the magnetically-encodable material in proximity to a semiconductor mass with at least one conductive region embedded therein. An electrical current is generated through the semiconductor mass. The current flows in a direction approximately parallel to the magnetically-encodable material. The semiconductor mass is magnetically biased with a magnetic field originating from a source other than the magnetically-encodable disc. The biasing magnetic field is approximately perpendicular to the magnetically-encodable material. Finally, a change in resistance to current flowing through the semiconductor mass is detected. The change in resistance indicates magnitude and direction of the magnetic field stored upon the magnetically-encodable material.

According to yet another embodiment of the invention, a method of manufacturing a semiconductor/metal read head involves providing a ceramic wafer. Next, a first conductive shield is deposited upon the ceramic wafer. Then, a first layer of insulating material is deposited atop the conductive shield. Thereafter, an alternating set of layers of semiconductor material and conductive material is deposited. The alternating set of layers has a semiconductor layer as a first layer and a semiconductor layer as a final layer. Next, a first photoresistive mask is applied atop the final semiconductor layer. Then, unmasked regions of the alternating semiconductor and conductor layers are etched away, until the first layer of insulating material is reached. The first photoresistive mask is then removed. Thereafter, a semiconductor material is deposited atop the structure remaining after the etching process. A second photoresistive mask is then applied atop the region formerly masked by the first mask. Next, a layer of conductive material is deposited to form contact pads. Thereafter, the second mask is removed. A second layer of insulating material is deposited atop the conductive material and atop the region formerly covered by the second mask. Finally a second conductive shield is deposited atop the second layer of insulating material.

According to yet another embodiment of the invention, a method of manufacturing a semiconductor/metal read head involves providing a ceramic wafer. Next, a first conductive shield is deposited upon the ceramic wafer. Then, an alternating set of layers of semiconductor material and conductive material is deposited. The alternating set of layers has a semiconductor layer as a first layer and a semiconductor layer as a final layer. Next, a first photoresistive mask is applied atop the final semiconductor layer. Then, unmasked regions of the alternating semiconductor and conductor layers are etched away, until the first conductive shield is reached. The first photoresistive mask is then removed. Thereafter, a semiconductor material is deposited atop the structure remaining after the etching process. A second photoresistive mask is applied atop the region formerly masked by the first mask. Then, a layer of insulating material is deposited. Next, the second mask is removed. Finely, a second conductive shield is disposed atop the insulating material and atop the region formerly covered by the second mask.

According to yet another embodiment of the invention, a semiconductor/metal read head for detecting magnetic fields stored upon a magnetically-encodable material includes a semiconductor mass. Additionally, it includes a means for varying resistance across the semiconductor mass, based upon magnitude and polarity of a magnetic field in which the semiconductor mass is immersed.

These and various other features as well as advantages which characterize the present invention will be apparent from a reading of the following detailed description and a review of the associated drawings.

### BRIEF DESCRIPTION OF THE DRAWINGS

FIG. 1 depicts a read head known in the prior art.

FIG. 2 depicts a disc drive constructed in accordance with a preferred embodiment of the present invention.

FIG. 3 depicts a semiconductor/metal read head, in accordance with one embodiment of the invention.

FIG. 4 depicts the read head of FIG. 3 immersed in a magnetic field.

FIG. 5 depicts a Cartesian plane that shows generally the relationship between a magnetic field in which the read head of FIG. 4 is immersed and the resistance across the read head.

FIG. 6 depicts one scheme by which a read head may be magnetically biased.

FIG. 7 depicts another scheme by which a read head may be magnetically biased.

FIG. 8 depicts yet another scheme by which a read head may be magnetically biased.

FIG. 9 depicts yet another scheme by which a read head may be magnetically biased.

FIG. 10 depicts a read head, in accordance with one embodiment of the present invention.

FIG. 11 depicts another read head, in accordance with one embodiment of the present invention.

FIG. 12 depicts another embodiment of a CIP read head.

FIG. 13 depicts another embodiment of a CPP read head.

FIGS. 14-26 depict an exemplary method by which the CIP read head depicted in FIG. 12 may be constructed.

FIGS. 27-31 depict an exemplary method by which the CPP read head depicted in FIG. 13 may be constructed.

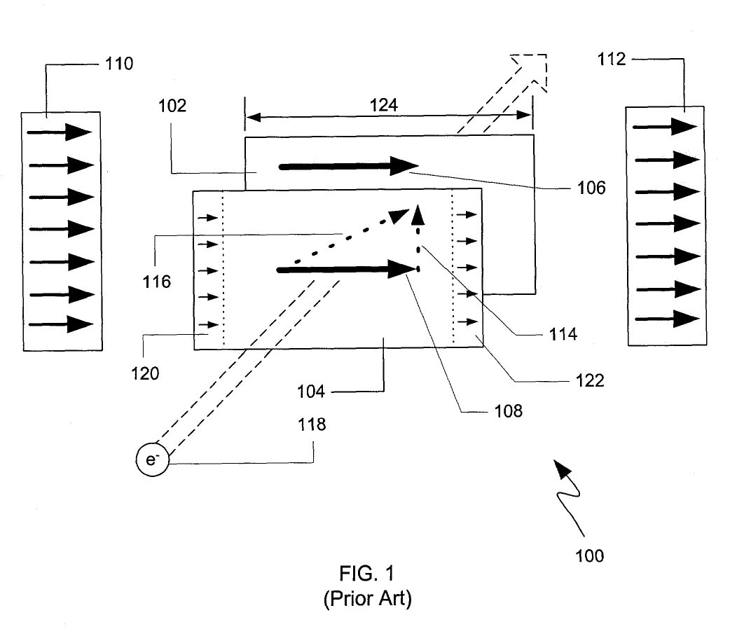

### DETAILED DESCRIPTION

Miniaturization can be achieved by making use of a read head that does not utilize magnetic layers. Such a read head is composed of a semiconductive mass with a conductive body embedded therein. To detect a magnetic field encoded on a magnetic storage surface, the read head is brought in proximity to the storage surface. An electrical current is driven through the semiconductive mass, in a direction perpendicular to the magnetic field stored upon the storage surface (stated another way, the current runs in a direction parallel to the storage surface). The electric field lines are always perpendicular to the boundary of the conductive body. In the absence of a magnetic field, the current travels across the semiconductive mass, along the electric field lines therein. Accordingly, the electrical current traverses the semiconductive mass, traveling a majority of its course via the conductive body embedded within the semiconductive mass. On the other hand, when influenced by a magnetic field that is perpendicular to the path of the electrical current, the current travels at an angle to the electric field lines. Much of the current traverses the semiconductive mass without traveling through the conductive body—a path more resistive to electrical current than a path extending through the conductive body. Thus, the electrical current experiences an elevated resistance when subjected to a magnetic field perpendicular to its course of travel. By driving a constant current through such a read head, the rise in resistance can be detected by observing a corresponding rise in voltage across the read head.

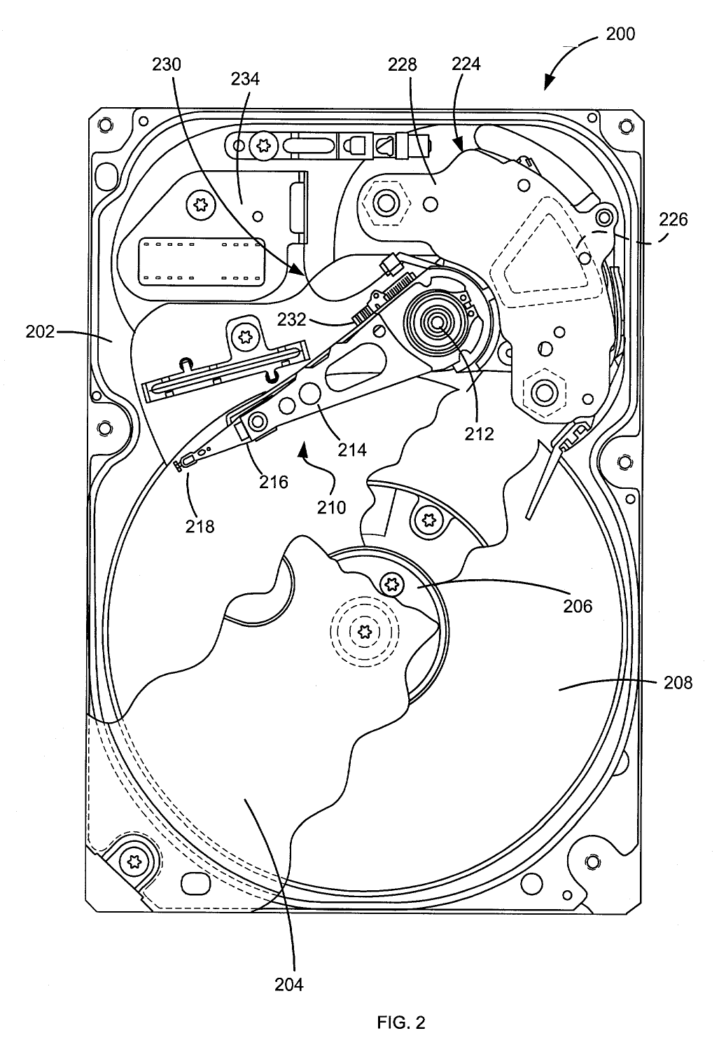

In the disclosure that follows, the discussion associated with FIG. 2 is intended to familiarize the reader with a disc drive in a general way. The remainder of the discussion (and the remainder of the figures) focuses more particularly upon various embodiments of the semiconductor/metal read head and methods of making it.

A disc drive 200 constructed in accordance with a preferred embodiment of the present invention is shown in FIG. 2. The disc drive 200 includes a base 202 to which various components of the disc drive 200 are mounted. A top cover 204, shown partially cut away, cooperates with the base 202 to form an internal, sealed environment for the disc drive in a conventional manner. The components include a spindle motor 206 which rotates one or more discs 208 at a constant high speed. Information is written to and read from tracks on the discs 208 through the use of an actuator assembly 210, which rotates during a seek operation about a bearing shaft assembly 212 positioned adjacent the discs 208. The actuator assembly 210 includes a plurality of actuator arms 214 which extend towards the discs 208, with one or more flexures 216 extending from each of the actuator arms 214. Mounted at the distal end of each of the flexures 216 is a head 218 which includes an air bearing slider enabling the head 218 to fly in close proximity above the corresponding surface of the associated disc 208.

During a seek operation, the track position of the heads 218 is controlled through the use of a voice coil motor (VCM) 224, which typically includes a coil 226 attached to the actuator assembly 210, as well as one or more permanent magnets 228 which establish a magnetic field in which the coil 226 is immersed. The controlled application of current to the coil 226 causes magnetic interaction between the permanent magnets 228 and the coil 226 so that the coil 226 moves in accordance with the well-known Lorentz relationship. As the coil 226 moves, the actuator assembly 210 pivots about the bearing shaft assembly 212, and the heads 218 are caused to move across the surfaces of the discs 208.

The spindle motor 206 is typically de-energized when the disc drive 200 is not in use for extended periods of time. The heads 218 are moved over park zones 220 near the inner diameter of the discs 208 when the drive motor is de-energized. The heads 218 are secured over the park zones 220 through the use of an actuator latch arrangement, which prevents inadvertent rotation of the actuator assembly 210 when the heads are parked.

A flex assembly 230 provides the requisite electrical connection paths for the actuator assembly 210 while allowing pivotal movement of the actuator assembly 210 during operation. The flex assembly includes a printed circuit board 232 to which head wires (not shown) are connected; the head wires being routed along the actuator arms 214 and the flexures 216 to the heads 218. The printed circuit board 232 typically includes circuitry for controlling the write currents applied to the heads 218 during a write operation and a preamplifier for amplifying read signals generated by the heads 218 during a read operation. The flex assembly terminates at a flex bracket 234 for communication through the base deck 202 to a disc drive printed circuit board (not shown) mounted to the bottom side of the disc drive 200.

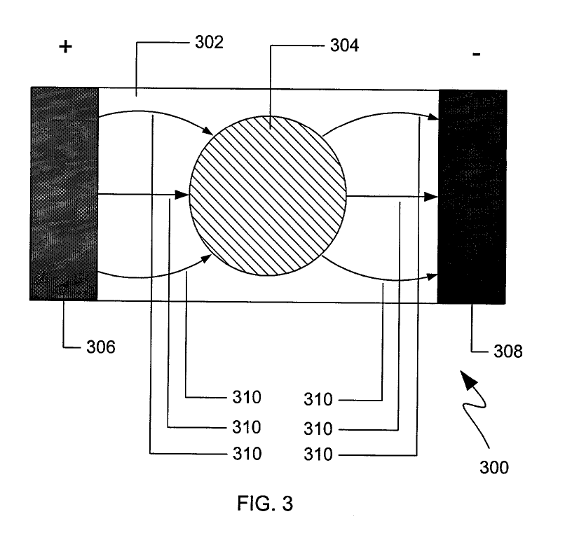

FIG. 3 depicts a semiconductor/metal read head 300, in accordance with one embodiment of the invention. The view depicted in FIG. 3 is from the vantage of the disc (also known as a “bottom” view, or an “air bearing surface” view). The structure of the read head 300 is invariant along the third, unpictured dimension running in and out of the page. The read head 300 possesses a semiconductive mass 302 with a conductive body 304 embedded therein. In the embodiment depicted in FIG. 3, the conductive body 304 is cylindrical. On either side of the read head 300, first and second conductive pads 306 and 308 are disposed.

The semiconductive mass 302 is a high-quality (high mobility) semiconductor matrix. For example, the semiconductive mass 302 may be composed of indium-antimonide (InSb) or gallium-arsenide (GaAs). The conductive body 304 and conductive posts 306 and 308 may be composed of a noble metal. For example, the conductive body 304 and conductive posts 306 and 308 may be composed of gold (Au) or silver (Ag). The conductive body 304 and conductive posts 306 and 308 may also be composed of a nonmetal conductor.

A voltage has been applied across the read head 300, with the first conductive pad 306 being at a voltage higher than the voltage of the second conductive pad 308. Accordingly, electric field lines 310 extend from the first conductive pad 306 to the second conductive pad 308. The electric field lines 310 run through the conductive body 304, approaching its periphery approximately perpendicular thereto. Thus, a charged particle injected into the read head 300 would experience a force:

F=Eq

Consequently, the charged particle would traverse the read head 300, moving along the electric field line 310 through the conductive body 304.

The semiconductive mass 302 is moderately resistive to conduction of electrical current. The conductive body 304, on the other hand, is virtually resistance free. Thus, by traversing the read head 300 by traveling a portion of the way through the conductive body 304, a charged particle experiences less resistance than if it had traveled exclusively via the semiconductive mass 302.

FIG. 4 depicts the read head 300 of FIG. 3 immersed in a magnetic field 400 that is running in a direction pointed out of the page. A negatively charged particle 402 is shown traversing the read head 300. The negatively charged particle 402 is traveling toward the first conductive pad 306, because it is a region of high voltage. As the charged particle 402 travels to the first conductive pad 306, it experiences a force due to the combined effects of both the electric field 310 and the magnetic field 400:

F=q[E+(v×B)]

As a result, the charged particle 402 no longer travels along the electric field lines 310. Instead, the charged particle 402 travels at an angle, Θ, to the electric field lines 310. This angle is referred to as the “Hall angle.” The Hall angle is determined by the formula:

Θ=tan⁻¹(eBτ/m*),

where e represents the carrier charge, B represents the magnetic field strength, τ represents the relaxation time of the semiconductor (the average time between collisions of a charged particle traversing the semiconductor and an imperfection within the semiconductor), and m* represents the effective mass of the carrier.

As a result of the above-stated equation, the greater the strength of the magnetic field in which the read head 300 is immersed, the greater the Hall angle. As the Hall angle grows, an increasingly greater fraction of the charged particles 402 may be directed around the conductive body 304, altogether (the remainder of the charged particles 402 enter the conductive body 304, but travel a protracted course through the semiconductive mass 302 before doing so). The longer a particle 402 travels within the semiconductive mass 302, the more resistance it experiences. This factor alone causes the total resistance experienced by the charged particle 402 to be relatively great. A second factor that elevates the resistance experienced by a charged particle 402 as it travels to the first conductive pad 306 is that, if it travels around the conductive body 304 altogether, it is forced to travel through a small cross-sectional area 404 bounded by the periphery of the conductive body 304 and the edge of the semiconductive mass 302. Since the resistance experienced by a charged particle is inversely proportional to the cross-sectional area through which it travels, travel through the small cross-sectional area 404 elevates the resistance experienced by the charged particle 402.

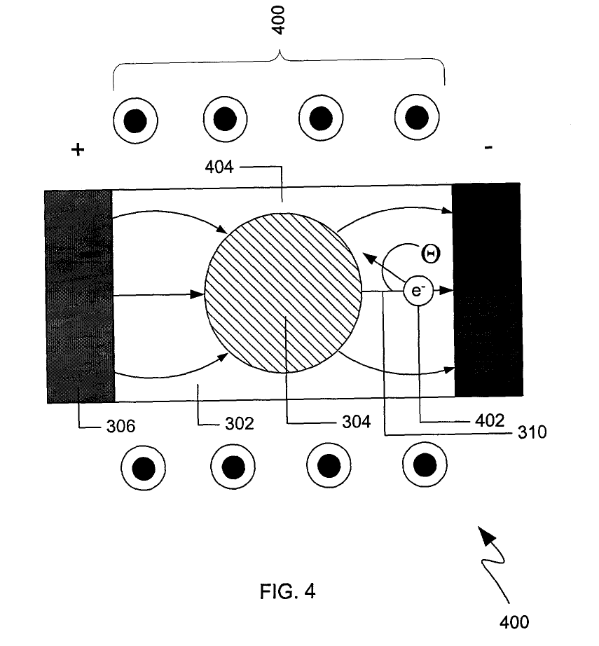

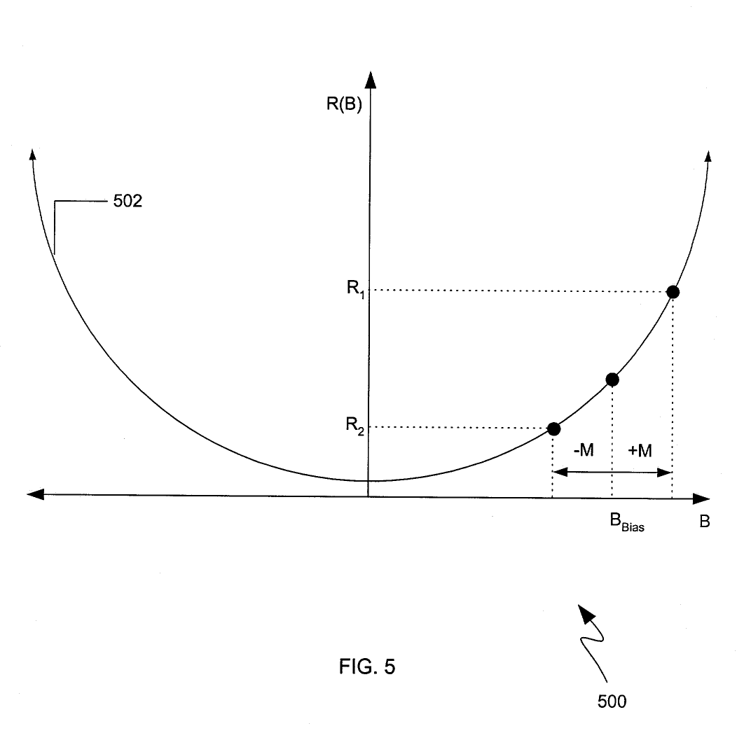

FIG. 5 depicts a Cartesian plane 500 that shows generally the relationship between a magnetic field in which the read head 300 is immersed and the resistance across the read head 300. Therein, the x-axis measures the magnitude of the magnetic field, and the y-axis measures resistance of the read head 300. As can be seen from the resistance curve 502 of FIG. 5, the resistance of the read head 300 is minimum in the absence of a magnetic field. However, as the magnitude of the magnetic field increases, the resistance of the read head 300 increases, too. As can also be seen from FIG. 5, the resistance curve 502 is symmetric about the y-axis. Thus, based solely upon observation of the read head's 300 resistance, the direction of the magnetic field cannot be determined. Stated another way, the resistance exhibited by the read head 300 in a magnetic field with a magnitude of X is the same as that exhibited in a magnetic field with the same magnitude but in the opposite direction.

To permit observation of the read head's 300 resistance to indicate direction (as well as magnitude) of the magnetic field, a biasing magnetic field may be applied to the read head 300. According to such a scheme, the read head 300 is biased at a magnetic magnitude of B_{Bias}. From such a bias point, B_{Bias}, immersion in a magnetic field with a magnitude of +M results in a resistance of R₁, while immersion in a magnetic field with a magnitude of −M results in a resistance of R₂. Thus, direction of a magnetic field is rendered determinable by use of a biasing magnetic field. In one embodiment of the present invention, the read head 300 is biased so as to exhibit a Hall angle of approximately 45° (±20°), in the absence of any magnetic field other than the biasing field.

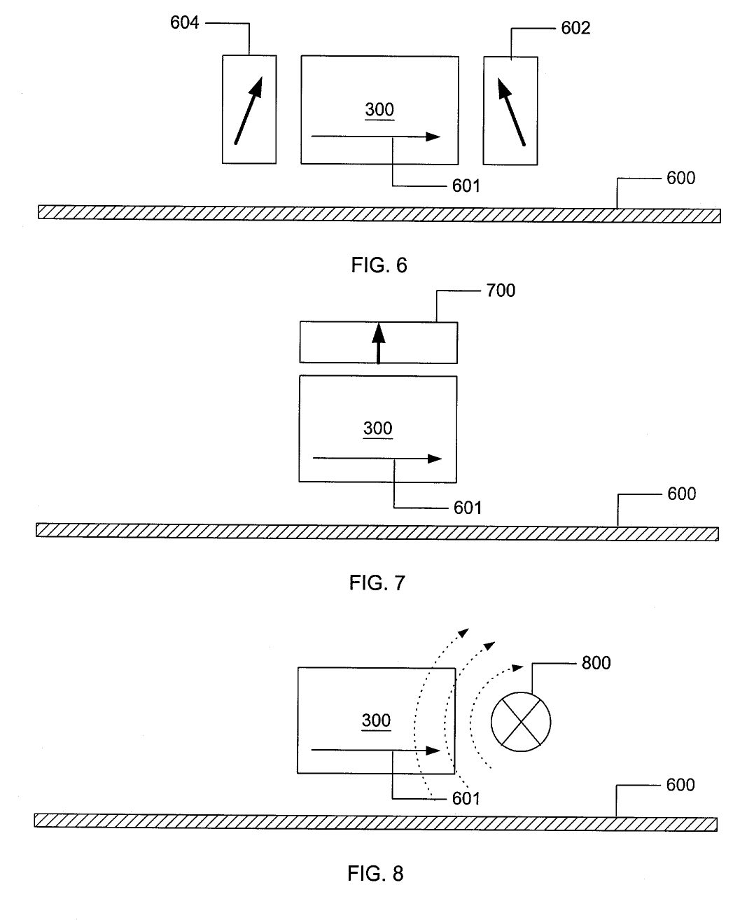

FIG. 6 depicts one scheme by which a read head 300 may be magnetically biased. As depicted in FIG. 6, the read head 300 is positioned over a magnetic storage surface 600, such as a disc within a disc drive. Electrical current travels across the read head 300 along a path that is parallel to the magnetic storage surface 600, as shown by arrow 601. A biasing magnetic field that is perpendicular to the magnetic storage surface 600 is established by virtue of a pair of magnets 602 and 604 located on opposite sides of the read head 300. In one embodiment, the magnets 602 and 604 are permanent magnets. Each magnet 602 and 604 produces a magnetic field throughout the body of the read head 300. The resulting magnetic field therein is equal to the vector sum of the magnetic field produced by each magnet 602 and 604. In one embodiment, the magnets 602 and 604 possess magnetization directions such that the resulting magnetic field throughout the body of the read head 300 is approximately normal to the magnetic storage surface 600. Preferably, the magnets 602 and 604 cooperate to form a biasing magnetic field that causes a Hall angle of approximately 45° (±20°) throughout the body of the read head 300.

FIG. 7 depicts another scheme by which a read head 300 may be magnetically biased. As in FIG. 6, the read head 300 is positioned over a magnetic storage surface 600, such as a disc within a disc drive. Also as in FIG. 6, electrical current travels across the read head 300 along a path that is parallel to the magnetic storage surface 600, as shown by arrow 601. Per the embodiment of FIG. 7, a biasing magnetic field that is perpendicular to the magnetic storage surface 600 is established by virtue of a magnet 700 located on the opposite side of the read head 300 as the magnetic storage surface 600. In one embodiment, the magnet 700 is a permanent magnet. Preferably, the magnet 700 creates a biasing magnetic field that causes a Hall angle of approximately 45° (±20°) throughout the body of the read head 300.

FIG. 8 depicts yet another scheme by which a read head 300 may be magnetically biased. As in FIGS. 6 and 7, the read head 300 is positioned over a magnetic storage surface 600, such as a disc within a disc drive. Also as in FIGS. 6 and 7, electrical current travels across the read head 300 along a path that is parallel to the magnetic storage surface 600, as shown by arrow 601. Per the embodiment of FIG. 8, a biasing magnetic field that is perpendicular to the magnetic storage surface 600 is established by virtue of a magnetic field created by current traveling through a conductor 800. In the depicted embodiment, the current travels along a path that is approximately parallel to the magnetic storage surface 600. Thus, a biasing magnetic field that is approximately perpendicular to the magnetic storage surface 600 is created throughout the read head 300. In one embodiment, a current level is chosen, so as to produce a Hall angle of approximately 45° (±20°) throughout the body of the read head 300. Although FIG. 8 depicts a single conductor 800, one skilled in the art understands that many such conductors may be used together to achieve the same end. Additionally, it should be noted that an electrical current may be conducted through shields (not depicted in FIG. 8) that surround the read head 300 (the shields permit the read head 300 to read a single quantum or “bit” of data from a track at one time) to generate the biasing magnetic field.

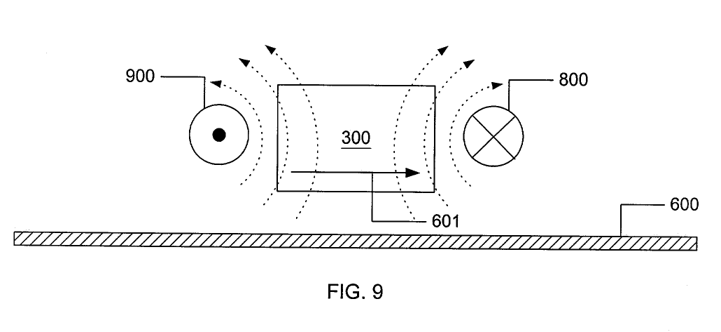

FIG. 9 depicts yet another scheme by which a read head 300 may be magnetically biased. The scheme depicted in FIG. 9 is similar to the scheme depicted in FIG. 8 As in the scheme of FIG. 8, the read head 300 is positioned over a magnetic storage surface 600, such as a disc within a disc drive. Also as in FIG. 8 electrical current travels across the read head 300 along a path that is parallel to the magnetic storage surface 600, as shown by arrow 601. Per the embodiment of FIG. 9, a biasing magnetic field that is perpendicular to the magnetic storage surface 600 is established by virtue of a magnetic field created by current traveling through a pair of conductors 800 and 900. The conductors 800 and 900 are located on opposite ends of the read head 300 and carry current in opposite directions, thereby cooperating to form a biasing magnetic field that is perpendicular to the magnetic storage surface 600. In one embodiment, a current level is chosen, so as to produce a Hall angle of approximately 45° (±20°) throughout the body of the read head 300. Additionally, it should be noted that an electrical current may be conducted through shields (not depicted in FIG. 9) that surround the read head 300 (to permit it to read a single quantum or “bit” of data from a track at one time) to cooperatively generate the biasing magnetic field.

Any combination of the magnetic biasing schemes depicted in FIGS. 6-9 may be employed. In addition, the magnetic biasing schemes depicted in FIGS. 6-9 may be employed in concert with other schemes.

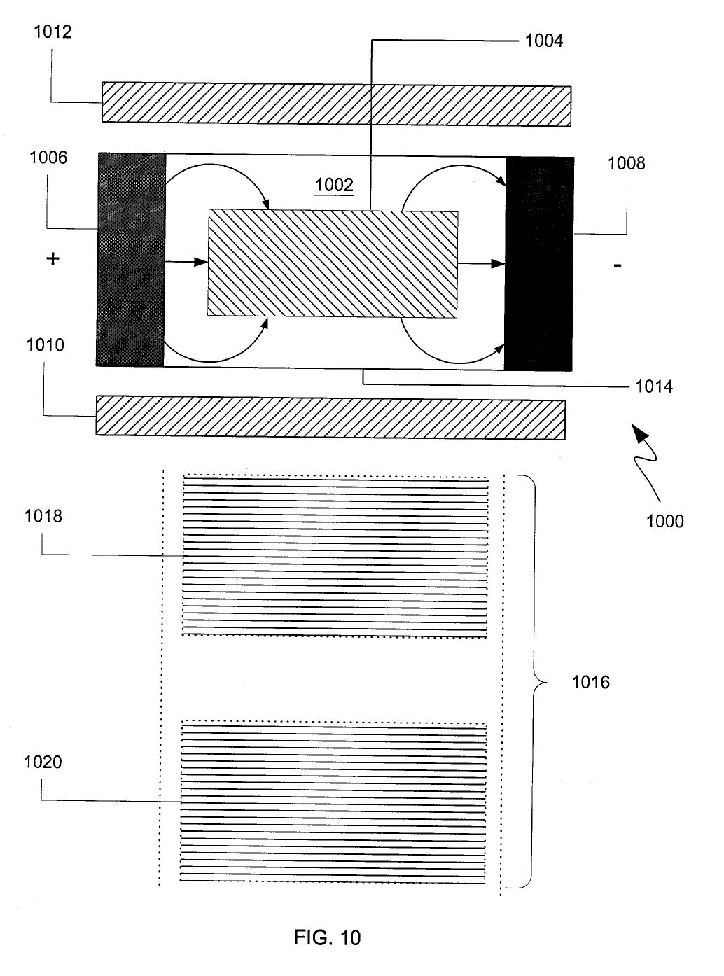

FIG. 10 depicts a read head 1000, in accordance with one embodiment of the present invention. The view depicted in FIG. 10 is an air bearing surface view. The structure of the read head 1000 is invariant along the third, unpictured dimension, running in and out of the page. The read head 1000 is structurally similar to the read head 300 depicted in FIG. 3. The read head 1000 of FIG. 10 includes a semiconductive mass 1002 with a conductive body 1004 embedded therein. On opposite sides of the read head 1000, conductive pads 1006 and 1008 are disposed. Electrical current travels between the conductive pads 1006 and 1008. On opposite sides of the read head 1000, and perpendicular to the conductive pads 1006 and 1008, conductive shields 1010 and 1012 are disposed. In one embodiment of the invention, the shields 1010 and 1012 are made of nickel-iron (NiFe).

In the embodiment of FIG. 10, the conductive body 1004 has a rectangular face. Its body is prismatic. This embodiment of the read head 1000 is referred to as a “current in plane” (CIP) read head, because electrical current passes through the head 1000 in a path parallel to the plane of construction of the head (the read head 1000 is produced in layers, one stacked atop another, beginning from the bottom edge 1014 of the read head 1000). CIP read heads possess an advantage in that they may be miniaturized to permit a narrower track width, without elevating the normative resistance of the read head 1000. That this is the case may be verified from understanding the orientation of the read head 1000, relative to a data track. A small segment of a data track 1016 is depicted in FIG. 10. From the vantage presented in FIG. 10, the data track 1016 would pass over and obstruct the read head 1000, if it were shown in its entirety. The segment of the data track 1016 depicted has two quanta of data 1018 and 1020 stored thereon. The conductive shields 1010 and 1012 cooperate to form a magnetic barrier that isolates the read head 1000 from the magnetic influence of data quanta adjacent to the particular quantum over which the head 1000 is located. For example, if the read head 1000 were located over data quantum 1018, shield 1010 would prevent the magnetic field emanating from data quantum 1020 from reaching and influencing the read head 1000. As can also be seen from FIG. 10, the width of the read head 1000 corresponds with the width of the data track 1016.

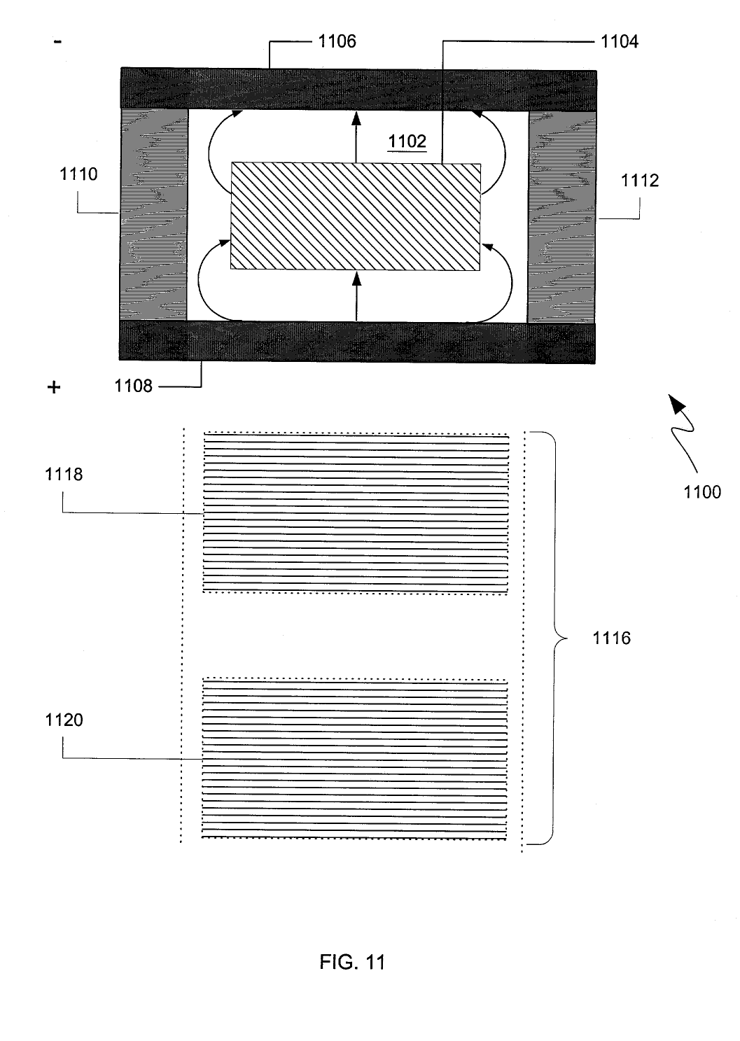

FIG. 11 depicts a read head 1100, in accordance with another embodiment of the present invention. Once again, the view depicted in FIG. 11 is an air bearing surface view. As in FIG. 10, the structure of the read head 1100 is invariant along the third, unpictured dimension, running in and out of the page. The read head 1100 depicted in FIG. 11 is a “current perpendicular to plane” (CPP) read head. As can be seen from FIG. 11, the electrical current runs in a direction that is perpendicular to current in a CIP read head, but the current is still parallel to the magnetic storage surface over which the read head 1100 is positioned. The CPP read head 1100 depicted in FIG. 11 possesses a semiconductive mass 1102 with a conductive body 1104 embedded therein. The conductive body 1104 has a rectangular face. Its body is prismatic. On opposite sides of the read head 1100, conductive pads 1106 and 1108 are disposed. In the embodiment depicted in FIG. 11, the conductive pads 1106 and 1108 double as conductive shields. Electrical current travels between the conductive pads 1106 and 1108. Disposed on opposite sides of the read head 1100, and extending between the conductive pads/conductive shields 1106 and 1108 is an insulation layer 1110 and 1112. The insulation layer 1110 and 1112 is a dielectric, and may be made of alumina (Al₂O₃), for example. The insulation layer 1110 and 1112 prevents a short circuit from developing between the conductive pads/conductive shields 1106 and 1108.

CPP read heads possess an advantage in that they may be miniaturized to permit a greater number of data quanta per linear unit to be stored on a data track, without elevating the normative resistance of the read head 1100. That this is the case may be verified from understanding the orientation of the read head 1100, relative to a data track. A small segment of a data track 1116 is depicted in FIG. 11. From the vantage presented in FIG. 11, the data track 1116 would pass over and obstruct the read head 1100, if it were shown in its entirety. The segment of the data track 1116 depicted has two quanta of data 1118 and 1120 stored thereon. The conductive shields 1110 and 1112 cooperate to form a magnetic barrier that isolates the read head 1100 from the magnetic influence of data quanta adjacent to the particular quantum over which the head 1100 is located. For example, if the read head 1100 were located over data quantum 1118, shield 1110 would prevent the magnetic field emanating from data quantum 1120 from reaching and influencing the read head 1100.

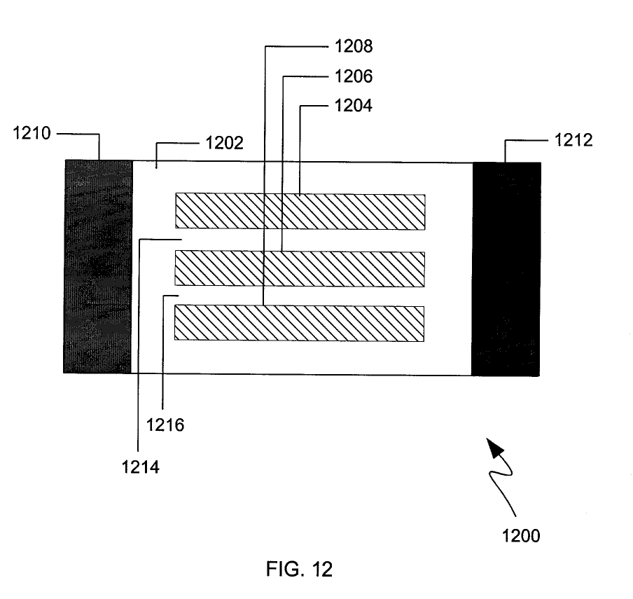

FIG. 12 depicts another embodiment of a CIP read head 1200. As in previous figures, the view depicted in FIG. 12 is an air bearing surface view of the read head 1200. The structure of the read head 1200 is invariant along the third, unpictured dimension, running in and out of the page. The CIP read head 1200 includes a semiconductive mass 1202. Embedded within the semiconductive mass 1202 are three conductive bodies 1204, 1206 and 1208. Disposed on opposite sides of the read head are two conductive pads 1210 and 1212. Electrical current runs between the conductive pads 1210 and 1212.

As can be seen from FIG. 12, the three conductive bodies 1204, 1206 and 1208 are approximately parallel to each other. The purpose of providing three conductive bodies, as opposed to a single conductive body is to allow for semiconductive passages 1214 and 1216. The semiconductive passages 1214 and 1216 provide a semiconductive pathway between the conductive pads 1210 and 1212. Thus, under the influence of a magnetic field, a greater opportunity exists for current to pass from one pad 1210 or 1212 to the other pad 1210 or 1212 without passing through a conductive body 1204, 1206, 1208. Such an arrangement heightens the sensitivity of the read head 1200 to immersion in a magnetic field, because it allows for a greater fraction of the current to pass through high-resistance paths, when exposed to a magnetic field. Although the embodiment in FIG. 12 depicts three conductive bodies 1204, 1206, 1208 embedded within the semiconductive mass 1202, any number of conductive bodies may be used.

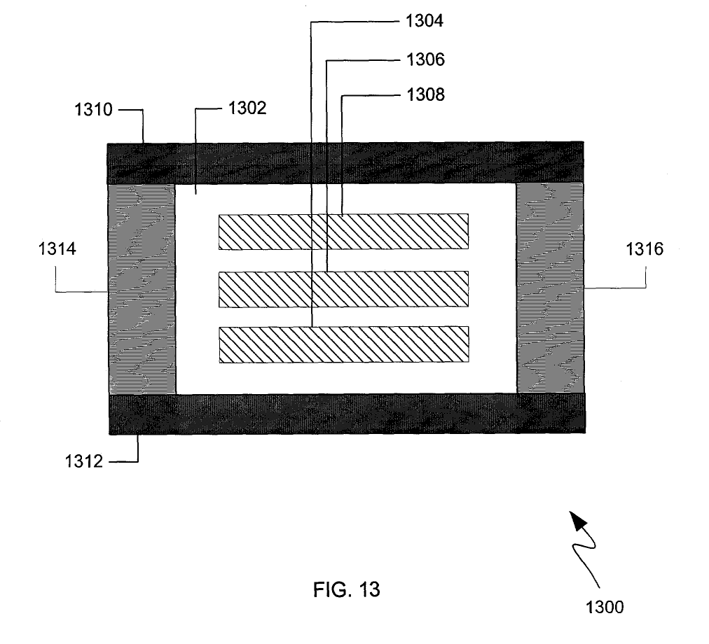

FIG. 13 depicts another embodiment of a CPP read head 1300. As in previous figures, the view depicted in FIG. 13 is an air bearing surface view of the read head 1300. The structure of the read head 1300 is invariant along the third, unpictured dimension, running in and out of the page. The CPP read head 1300 includes a semiconductive mass 1302. Embedded within the semiconductive mass 1302 are three conductive bodies 1304, 1306 and 1308. Disposed on opposite sides of the read head are two conductive pads 1310 and 1312. The contact pads 1310 and 1312 may double as conductive shields, or may be separate structures therefrom. Electrical current runs between the conductive pads 1310 and 1312. Disposed on opposite sides of the read head 1300, and extending between the conductive pads 1310 and 1312 are insulation layers 1314 and 1316. As can be seen, the three conductive bodies 1304, 1306 and 1308 are approximately parallel to each other. Although the embodiment in FIG. 13 depicts three conductive bodies 1304, 1306, 1308 embedded within the semiconductive mass 1302, any number of conductive bodies may be used.

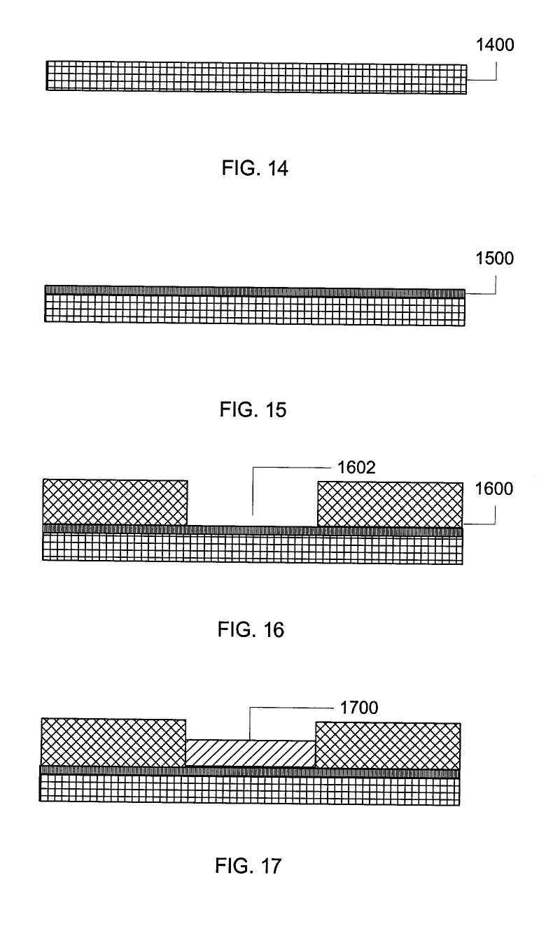

FIGS. 14-26 depict an exemplary method by which the CIP read head 1200 depicted in FIG. 12 may be constructed. In the sequence of figures that follow, a CIP read head is depicted in various stages of fabrication. FIGS. 14-26 are air bearing surface views.

As depicted by FIG. 14, production of a CIP read head commences by providing a ceramic wafer 1400. Next, as depicted in FIG. 15, a conductive seed layer 1500 is deposited atop the ceramic wafer. Atop the conductive seed layer 1500, a mask is laid, so as to cover a region 1602 in which a conductive shield is to be developed by electroplating. A photoresistive layer 1600 is deposited atop the unmasked regions and atop the mask; the mask is subsequently removed, resulting in the structure shown in FIG. 16.

The structure of FIG. 16 is immersed in a chemical bath, for the purpose of growing the conductive shield via electroplating. An electrical current is propagated through the wafer 1400 and the conductive seed layer 1500, and into the chemical bath. The current is unable to pass through the photoresistive layer 1600, because the photoresistive layer is a dielectric. Thus current only flows into the chemical bath through the region 1602 that had previously been masked. Accordingly, a shield 1700 is developed via electroplating in a region projecting directly upward from the previously masked region 1602.

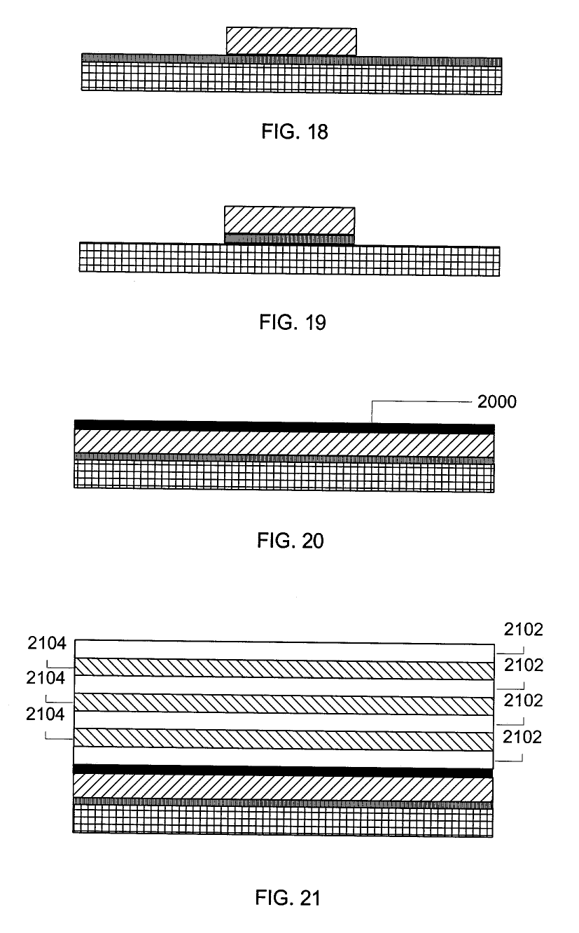

After electroplating of the shield 1700, the photoresistive layer 1600 is removed by use of a chemical solution; the resulting structure shown in FIG. 18. Thereafter, the seed layer 1500 is removed via etching; the resulting structure is shown in FIG. 19. The seed layer 1500 may be removed via a dry etching process such as ion milling, or may be removed via a wet etching process, such as via chemical solution.

FIGS. 20-26 are close-up views of the developing CIP read head, and focus only on the region of space directly above/below the shield 1700 that was built during the electroplating process. Atop the shield 1700, an insulation layer 2000 is deposited, as shown in FIG. 20. Next, atop the insulation layer 2000, a set of alternating layers of semiconductor 2102 and conductive material 2104 are deposited, with the first an final layers of the set being of semiconductive material 2102. The resulting structure is shown in FIG. 21. Although FIG. 21 depicts three layers of conductive material 2104, any number of layers of conductive material 2104 may be used.

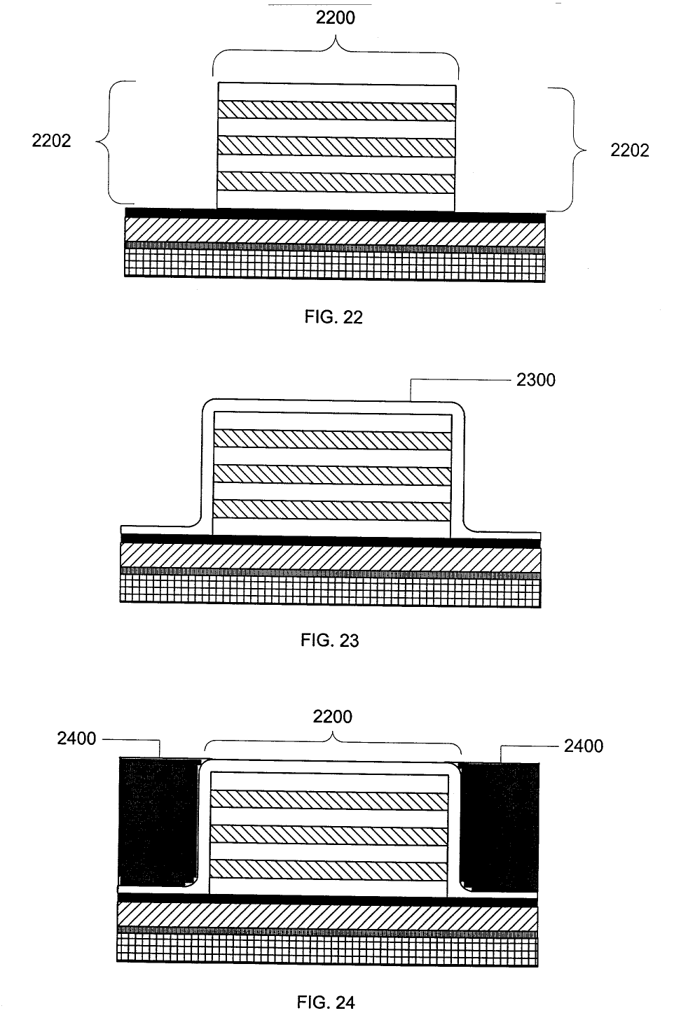

After the set of alternating layers 2102 and 2104 has been deposited, a photoresistive mask is laid atop the structure. The mask is used to protect that region 2200 beneath the mask from a subsequent etching process that is used to remove the alternating layers 2102 and 2104. Unmasked regions 2202 of the alternating layers 2102 and 2104 are removed by the etching process. After the etching process, the photoresistive mask is removed, as described earlier. The resulting structure is depicted in FIG. 22. Next, a semiconductive layer 2300 is deposited atop the structure, as shown in FIG. 23.

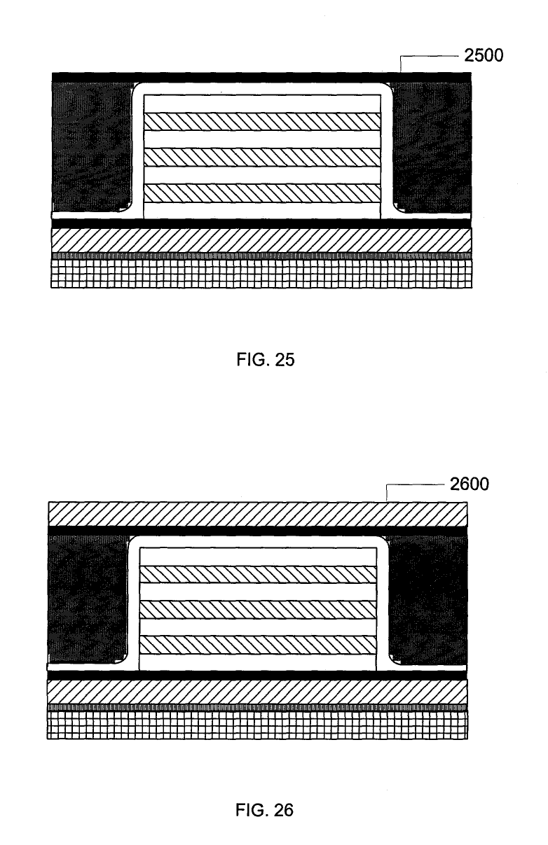

After deposition of the semiconductive layer 2300, the previously masked region 2200 is again masked, and a noble metal 2400, used as contact pads 2400 for the read head, is deposited. The mask is subsequently removed, and the resulting structure is depicted in FIG. 24. Next, an insulation layer 2500 is deposited as shown in FIG. 25. Finally, a shield 2600 is electroplated atop the insulation layer, according the steps described with reference to FIGS. 15-17. The resulting CIP read head is shown in FIG. 26.

As can be seen from FIGS. 14-26, each of the various layers of the read head are approximately parallel to each other and to the ceramic wafer 1400 atop which they were deposited.

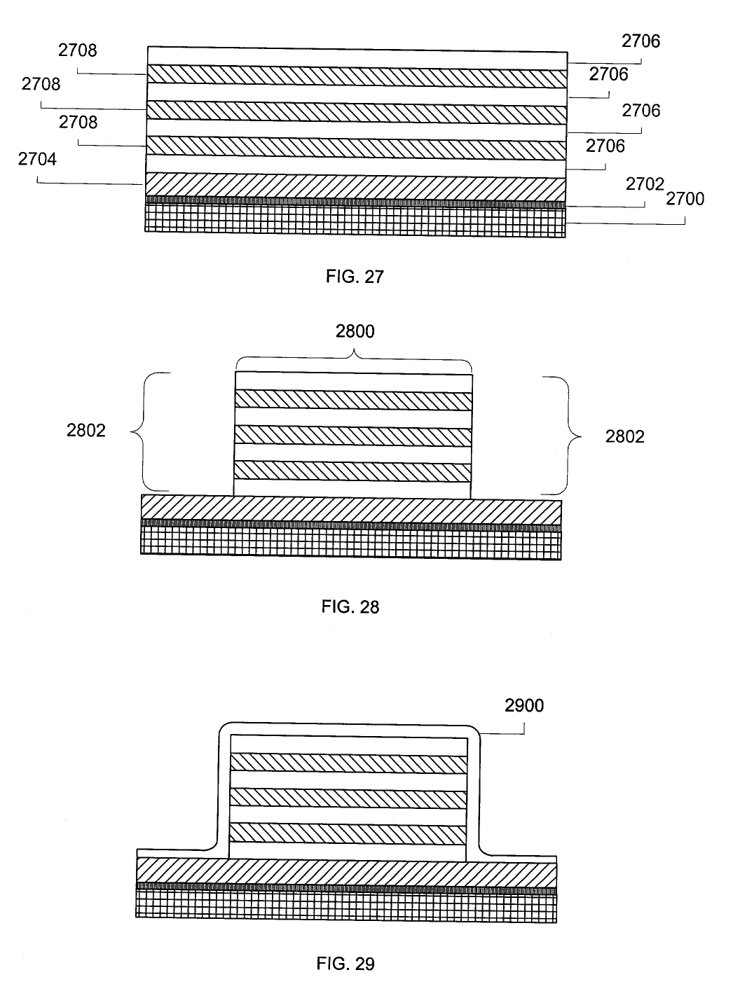

FIGS. 27-31 depict an exemplary method by which the CPP read head 1300 depicted in FIG. 13 may be constructed. In the sequence of figures that follow, a CPP read head is depicted in various stages of fabrication. FIGS. 27-31 are air bearing surface views.

FIG. 27 begins with a depiction of a structure resulting from execution of the steps described with reference to 14-21, with the exception that the step of depositing an insulation layer was not carried out. Thus, the structure depicted in FIG. 27, consists of a wafer 2700, a seed layer 2702, a shield 2704, and alternating layers of semiconductive material 2706 and conductive material 2708.

After the set of alternating layers 2706 and 2708 has been deposited, a photoresistive mask is laid atop the structure. The mask is used to protect that region 2800 beneath the mask from a subsequent etching process that is used to remove the alternating layers 2706 and 2708. Unmasked regions 2802 of the alternating layers 2706 and 2708 are removed by the etching process. After the etching process, the photoresistive mask is removed, as described earlier. The resulting structure is depicted in FIG. 28. Next, a semiconductive layer 2900 is deposited atop the structure, as shown in FIG. 29.

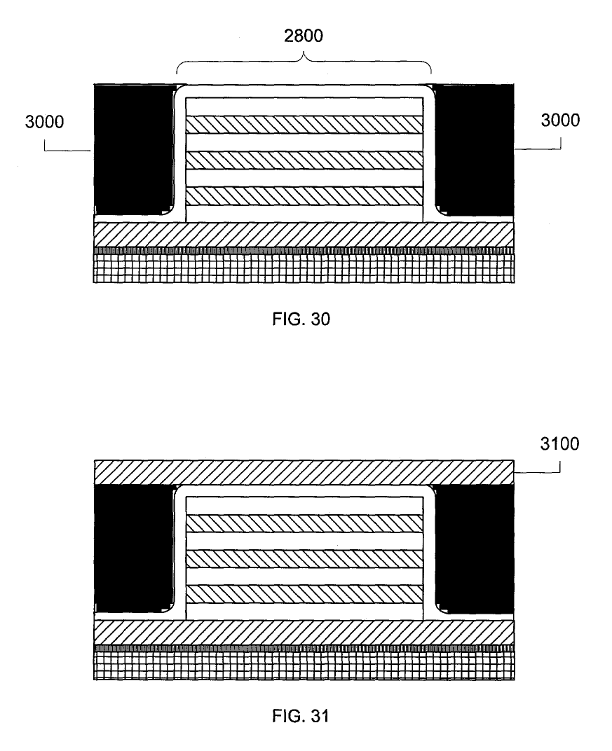

After deposition of the semiconductive layer 2900, the previously masked region 2800 is again masked, and an insulation layer 3000 is deposited. The mask is subsequently removed, and the resulting structure is depicted in FIG. 30. Finally, a shield 3100 is electroplated atop the structure, according the steps described with reference to FIGS. 15-17. The resulting CPP read head is shown in FIG. 31.

As can be seen from FIGS. 27-31, each of the various layers of the CPP read head are approximately parallel to each other and to the ceramic wafer 2700 atop which they were deposited.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, other forms of materials may be used to construct the read head disclosed herein. Additionally, the precise shapes of the various layers/features of the red head disclosed herein are subject to alteration, as well. Numerous other changes may be made which will readily suggest themselves to those skilled in the art and which are encompassed in the spirit of the invention disclosed and as defined in the appended claims.

What is claimed is:

1. A disc drive employing a semiconductor/metal read head, the read head comprising:
a ceramic wafer oriented approximately perpendicular to a disc within the disc drive;
a semiconductor mass disposed upon the ceramic wafer;
at least one conductive layer embedded within the mass, the at least one conductive layer possessing a surface approximately parallel to the wafer;
conductive contact pads disposed on opposite sides of the semiconductor mass; and
a bias element in proximity to the semiconductor mass, the bias element producing a biasing magnetic field within the semiconductor mass.

2. The disc drive of claim 1, wherein the semiconductor mass comprises indium-antimonide (InSb).

3. The disc drive of claim 1, wherein the semiconductor mass comprises gallium-arsenide (GaAs).

4. The disc drive of claim 1, wherein the conductive mass comprises gold (Au).

5. The disc drive of claim 1, wherein the conductive mass comprises silver (Ag).

6. The disc drive of claim 1, further comprising conductive shields disposed on opposite sides of the semiconductor mass.

7. The disc drive of claim 7, wherein the conductive shields each possess a surface that is approximately parallel to the ceramic wafer.

8. The disc drive of claim 6, wherein the conductive shields comprise nickel-iron (NiFe).

9. The disc drive of claim 1, wherein the conductive contact pads comprise conductive shields, each conductive shield possessing a surface that is approximately parallel to the ceramic wafer.

10. The disc drive of claim 9, further comprising a first and second insulation layer disposed on opposite sides of the semiconductor mass, the first and second insulation layers extending between the conductive shields.

11. The disc drive of claim 10, wherein the first and second insulation layers comprise alumina (Al₂O₃).

12. The disc drive of claim 1, comprising more than one conductive layer embedded within the mass, wherein each of the more than one conductive layers are approximately parallel to the ceramic wafer.

13. The disc drive of claim 1, wherein the conductive layer is approximately prismatic, wherein the base of the prism is approximately parallel to the ceramic wafer.

14. The disc drive of claim 1, wherein the biasing element comprises a permanent magnet located on the opposite side of the semiconductor mass from the disc.

15. The disc drive of claim 1, wherein the biasing element comprises a conductor configured to carry an electrical current in a direction approximately parallel to the disc.

16. The disc drive of claim 1, wherein the biasing element comprises a pair of magnets on opposite sides of the semiconductor mass, each magnet having a magnetic pole, such that the vector sum of the magnetic poles is a vector approximately normal to a disc within the disc drive.

17. A method of detecting a magnetic field stored upon magnetically-encodable material, the method comprising:
(a) bringing a region of the magnetically-encodable material in proximity to a semiconductor mass with at least one conductive region embedded therein;
(b) generating an electrical current through the semiconductor mass, the current flowing in a direction approximately parallel to the magnetically-encodable material;
(c) magnetically biasing the semiconductor mass with a magnetic field originating from a source other than the magnetically-encodable disc, the magnetic field being approximately perpendicular to the magnetically-encodable material; and
(d) detecting a change in resistance to current flowing through the semiconductor mass with the embedded conductive region, the change in resistance indicating magnitude and direction of the magnetic field stored upon the magnetically-encodable material.

18. The method of claim 17, wherein biasing step (c) comprises orienting a permanent magnet on an opposite side of the semiconductor mass from the disc.

19. The method of claim 17, wherein biasing step (c) comprises generating an electrical current in proximity to the semiconductor mass, the electrical current flowing in a direction approximately parallel to the disc.

20. The method of claim 17, wherein biasing step (c) comprises orienting a pair of magnets on opposite sides of the semiconductor mass, each magnet having a magnetic pole, such that the vector sum of the magnetic poles is a vector approximately normal to a disc within the disc drive.

21. The method of claim 17, wherein the semiconductor mass is disposed upon a ceramic wafer, the ceramic wafer being approximately perpendicular to the magnetically encodable material.

22. The method of claim 21, wherein the semiconductor mass possesses more than one conductive region embedded therein.

23. A method of manufacturing a semiconductor/metal read head, comprising steps of:
(a) providing a ceramic wafer;
(b) disposing a first conductive shield upon the ceramic wafer;
(c) depositing an alternating set of layers of semiconductor material and conductive material, wherein the alternating set of layers has a semiconductor layer as a first layer and a semiconductor layer as a final layer;
(d) applying a first photoresistive mask atop the final semiconductor layer;
(e) etching away unmasked regions of the alternating semiconductor and conductor layers, until the first conductive shield is reached;
(f) removing the first photoresistive mask;
(g) depositing a semiconductor material atop the structure remaining after the etching process;
(h) applying a second photoresistive mask atop the region formerly masked by the first mask;
(i) depositing a layer of insulating material;
(j) removing the second mask; and
(k) disposing a second conductive shield atop the insulating material and atop the region formerly covered by the second mask.

24. The method of claim 23, wherein the semiconductor material applied in steps (c) and (g) comprises indium-antimonide (InSb).

25. The method of claim 23, wherein the semiconductor material deposited in steps (c) and (g) comprises gallium-arsenide (GaAs).

26. The method of claim 23, wherein the conductive material deposited in step (c) comprises gold (Au).

27. The method of claim 23, wherein the conductive material deposited in step (c) comprises silver (Ag).

28. The method of claim 23, wherein the insulating material deposited in step (i) comprises alumina (Al₂O₃).

29. The method of claim 23, wherein the shields disposed in steps (b) and (k) comprise Nickel-Iron (NiFe).

30. The method of claim 23, wherein steps (b) and (k) are accomplished via electroplating.

31. A semiconductor/metal read head for detecting magnetic fields stored upon a magnetically-encodable material, the read head comprising:
a semiconductor mass; and
a means for varying resistance across the semiconductor mass based upon magnitude and polarity of a magnetic field in which the semiconductor mass is immersed.
